(19) United States
(12) Patent Application Publication
(10) Pub. No.: US 2024/0314672 A1
(43) Pub. Date: Sep. 19, 2024

(54) METHOD FOR TRAFFIC RELAY FROM NETWORK TO UE

(71) Applicant: ZTE CORPORATION, Shenzhen (CN)

(72) Inventor: Hao DONG, Shenzhen (CN)

(73) Assignee: ZTE CORPORATION, Shenzhen (CN)

(21) Appl. No.: 18/613,208

(22) Filed: Mar. 22, 2024

Related U.S. Application Data
(63) Continuation of application No. PCT/CN2022/076887, filed on Feb. 18, 2022.

(51) Int. Cl. H04W 40/22; H04W 4/06

(52) U.S. Cl. CPC H04W 40/22; H04W 4/06

(57) ABSTRACT

Method, device and computer program product for wireless communication are provided. A method includes: determining, by a relay wireless communication terminal, whether to change a communication mode with remote wireless communication terminals in response to that a number of the remote wireless communication terminals receiving a same broadcast or multicast traffic from a network is increased; and transmitting, by the relay wireless communication terminal to the remote wireless communication terminals, an indication that communications between the relay wireless communication terminal and the remote wireless communication terminals for transferring the broadcast or multicast traffic to the remote wireless communication terminals is changed from unicast communications to a broadcast or multicast communication in response to the relay wireless communication terminal determining to change the communication mode.

### CROSS-REFERENCE TO RELATED PATENT APPLICATIONS

This application is a Continuation of PCT Application No. PCT/CN2022/076887, filed Feb. 18, 2022, incorporated herein by reference in its entirety.

### TECHNICAL FIELD

This document is directed generally to wireless communications, and in particular to 5^{th} generation (5G) communications.

### BACKGROUND

In a mobile network, a User Equipment (UE) may desire to use services provided by the network even when the UE is not in a coverage of the network. For example, the UE may be in a building which obstructs network coverage. In this case, the UE which cannot connect to the network directly is called a Remote UE.

### SUMMARY

To extend network coverage to cell-edge and out-of-coverage Remote UE, another UE may act as a UE-to-Network Relay, when it is in a coverage of the network. The Remote UE may access the network via the UE-to-Network Relay. The Remote UE requests broadcast service or multicast service from the network through the UE-to-Network Relay. In turn, the UE-to-Network Relay transfers traffic from the network towards the Remote UE through a unicast link between the UE-to-Network Relay and the Remote UE.

This document relates to methods for traffic relay from a network to a UE, devices thereof and systems thereof.

In a case when multiple Remote UEs desire access to the network via the same UE-to-Network Relay, the traffic relayed to each of the Remote UEs through a respective unicast link may put a significant load on the UE-to-Network Relay.

By providing a more efficient method for traffic relay from the network to the Remote UEs, the traffic relay to a plurality of Remote UEs for the UE-to-Network Relay is facilitated. This way, the network is more resilient, the Remote UEs receive improved service, and the UE-to-Network Relay spends less resources.

One aspect of the present disclosure relates to a wireless communication method. In an embodiment, the wireless communication method includes: determining, by a relay wireless communication terminal (e.g., a relay UE), whether to change a communication mode with remote wireless communication terminals (e.g., remote UEs) in response to that a number of the remote wireless communication terminals receiving a same broadcast or multicast traffic from a network is increased; and transmitting, by the relay wireless communication terminal to the remote wireless communication terminals, an indication that communications between the relay wireless communication terminal and the remote wireless communication terminals for transferring the broadcast or multicast traffic to the remote wireless communication terminals is changed from unicast communications to a broadcast or multicast communication in response to the relay wireless communication terminal determining to change the communication mode.

Another aspect of the present disclosure relates to a wireless communication method. In an embodiment, the wireless communication method includes: receiving, by a remote wireless communication terminal from a relay wireless communication terminal, an indication that a communication for transferring a broadcast or multicast traffic from a network via the relay wireless communication terminal is changed from using a unicast communication to using a broadcast or multicast communication.

Another aspect of the present disclosure relates to a relay wireless communication terminal. In an embodiment, the wireless communication terminal includes a communication unit and a processor. The processor is configured to: determine whether to change a communication mode with remote wireless communication terminals in response to that a number of the remote wireless communication terminals receiving a same broadcast or multicast traffic from a network is increased; and transmit, to the remote wireless communication terminals, an indication that communications between the relay wireless communication terminal and the remote wireless communication terminals for transferring the broadcast or multicast traffic to the remote wireless communication terminals is changed from unicast communications to a broadcast or multicast communication in response to the relay wireless communication terminal determining to change the communication mode.

Another aspect of the present disclosure relates to a remote wireless communication terminal. In an embodiment, the wireless communication terminal includes a communication unit and a processor. The processor is configured to: receive, from a relay wireless communication terminal, an indication that a communication for transferring a broadcast or multicast traffic from a network via the relay wireless communication terminal is changed from using a unicast communication to using a broadcast or multicast communication.

Various embodiments may preferably implement the following features:

Preferably or in some embodiments, the relay wireless communication terminal transmits a disconnect request to the remote wireless communication terminals to release the unicast communications between the relay wireless communication terminal and the remote wireless communication terminal.

Preferably or in some embodiments, the relay wireless communication terminal determines a source address identification and a destination address identification for the broadcast according to broadcast service information.

Preferably or in some embodiments, the relay wireless communication terminal determines a source address identification and a destination address identification for the multicast communication according to group information of a multicast service.

Preferably or in some embodiments, the relay wireless communication terminal transfers the broadcast or multicast traffic to the remote wireless communication terminals according to a source address identification and a destination address identification for a broadcast or multicast service corresponding to the broadcast or multicast traffic.

Preferably or in some embodiments, the relay wireless communication terminal establishes a unicast communication with one of the remote wireless communication terminals.

Preferably or in some embodiments, the relay wireless communication terminal receives a request for a broadcast or multicast service from one of the remote wireless communication terminals.

Preferably or in some embodiments, the relay wireless communication terminal requests a broadcast or multicast service from the network in response to a serving cell of the relay wireless communication terminal advertising the broadcast or multicast service.

Preferably or in some embodiments, the relay wireless communication terminal transfers the broadcast or multicast traffic for the broadcast or multicast service from the network to the one of the remote wireless communication terminals via the unicast communication between the one of the remote wireless communication terminals and the relay wireless communication terminal.

Preferably or in some embodiments, the remote wireless communication terminal receives a disconnect request from the relay wireless communication terminals to release the unicast communications between the relay wireless communication terminal and the remote wireless communication terminal.

Preferably or in some embodiments, the remote wireless communication terminal determines a destination address identification for the broadcast according to broadcast service information.

Preferably or in some embodiments, the remote wireless communication terminal determines a destination address identification for the multicast communication according to group information of a multicast service.

Preferably or in some embodiments, the remote wireless communication terminal receives for the broadcast or multicast traffic from the network via the relay wireless communication terminal based on a destination address identification for a broadcast or multicast service.

Preferably or in some embodiments, the remote wireless communication terminal establishes a unicast communication with the relay wireless communication terminal.

Preferably or in some embodiments, the remote wireless communication terminal transmits a request for a broadcast or multicast service to the remote wireless communication terminal.

Preferably or in some embodiments, the remote wireless communication terminal receives the broadcast or multicast traffic for the broadcast or multicast service from the network via the unicast communication between the remote wireless communication terminal and the relay wireless communication terminal.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an illustration of a method according to an embodiment of the present disclosure.

FIG. 2 shows an illustration of a method according to a further embodiment of the present disclosure.

FIG. 3 relates to a schematic diagram of a wireless terminal 30 according to an embodiment of the present disclosure.

FIG. 4 relates to a schematic diagram of a wireless network node 40 according to an embodiment of the present disclosure.

### DETAILED DESCRIPTION

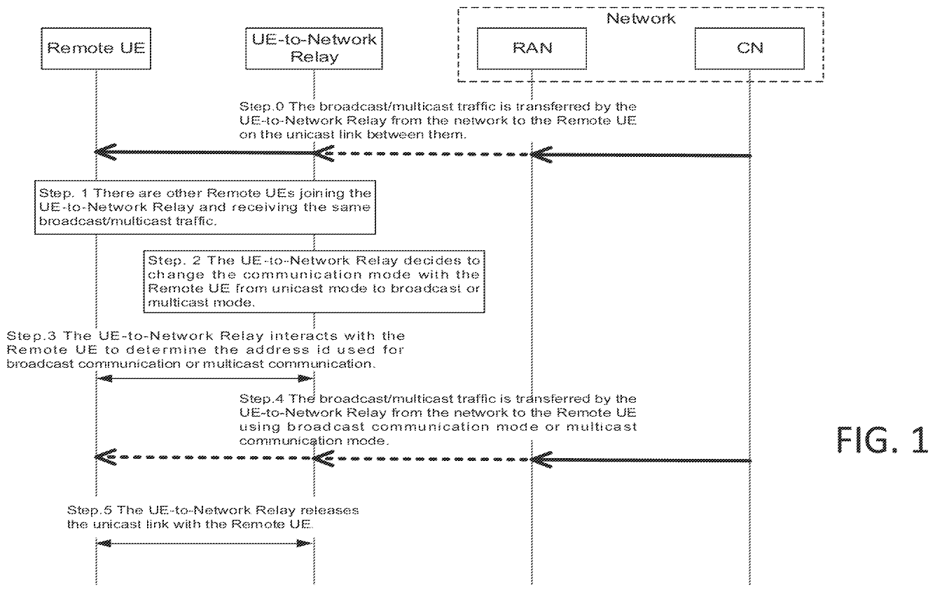

FIG. 1 illustrates switching a UE-to-Network Relay from a unicast communication mode to a broadcast/multicast communication mode. The method is illustrated in terms of procedures, each of which may involve a Core network (CN), a Radio access network (RAN), and/or a UE-to-Network Relay. Further, the procedures may involve at least one Remote UE.

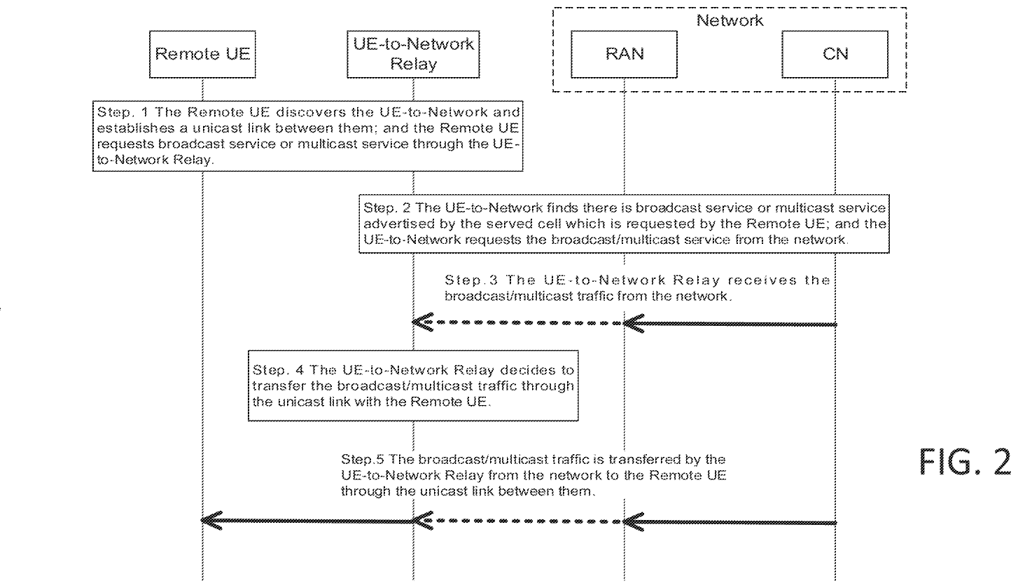

Initially, the UE-to-Network Relay sustains a unicast link to the Remote UE. The Remote UE requests broadcast/multicast service from the network via the UE-to-Network Relay. The network, i.e. the RAN, the CN, and/or an Application Server, provide the broadcast/multicast services and transmit broadcast/multicast traffic, which is intended for the Remote UE, to the UE-to-Network Relay. The establishment of the unicast link between the UE-to-Network Relay and the Remote UE is described in more detail below with reference to FIG. 2.

When the UE-to-Network Relay receives the broadcast/multicast traffic from the network, the UE-to-Network Relay relays the broadcast/multicast traffic from the network to the Remote UE using the unicast link, as illustrated as Step. 0.

When further Remote UEs join the UE-to-Network Relay, the UE-to-Network Relay establishes a unicast link to each of the Remote UEs. At least some of the Remote UEs may request at least some of the same broadcast/multicast services from the network. In this case, each of the concerned Remote UEs may receive the same broadcast/multicast traffic from the UE-to-Network Relay using the respective unicast link, as illustrated as Step. 1.

At one point illustrated as Step. 2, the UE-to-Network Relay may decide to switch the communication mode from a unicast communication mode to a broadcast/multicast communication mode. The decision may be based on the number of Remote UEs served by the UE-to-Network Relay simultaneously. For example, when the number of Remote UEs served exceeds a threshold, the UE-to-Network Relay may decide to switch to a broadcast/multicast communication mode. Alternatively, or additionally, the decision may be based on a number of Remote UEs which request the same services, on an extent of the broadcast/multicast traffic, on a load of the UE-to-Network Relay, or on a combination of any of the mentioned factors.

When the UE-to-Network Relay decides to switch to a broadcast/multicast communication mode, the UE-to-Network Relay indicates its decision to the Remote UEs. Further, the UE-to-Network Relay interacts with the Remote UEs to determine the address ids used for broadcast/multicast communication, as illustrated as Step. 3. More specifically, in a case when the services include a broadcast service, the UE-to-Network Relay determines a source address id and a destination address id for a broadcast traffic transmission according to a broadcast service information of the broadcast service. In a case when the services include a multicast service, the UE-to-Network Relay determines a source address id and a destination address id for a multicast traffic transmission according to a group information of the multicast service.

Similarly, in a case when the services include a broadcast service, the Remote UE determines the destination address id for the broadcast traffic transmission according to the broadcast service information. In a case when the services include a multicast service, the Remote UE determines the destination address id for the multicast traffic transmission according to the group information of the multicast service.

Based on the determined address ids, the UE-to-Network Relay operates in a broadcast/multicast operation mode as illustrated as Step. 4. When the UE-to-Network Relay receives the broadcast/multicast traffic from the network, it transfers the traffic towards the Remote UE using broadcast communication or multicast communication, respectively.

When the broadcast/multicast communication mode of the UE-to-Network Relay is established, the UE-to-Network Relay releases the unicast links with the concerned Remote UEs, as illustrated as Step. 5. The UE-to-Network Relay may send a disconnect request to a Remote UE, and the Remote UE may respond to the UE-to-Network Relay with a disconnect confirmation. In this case, the unicast link between the UE-to-Network Relay and the Remote UE is released.

FIG. 2 illustrates operation of the UE-to-Network Relay in a unicast communication mode.

In a first procedure illustrated as Step. 1, the Remote UE discovers the UE-to-Network Relay and established a unicast link between the Remote UE and the UE-to-Network Relay. The discovery procedure is used by the Remote UE to detect a UE, which is in proximity of the Remote UE, able to reach the network, and willing to act as UE-to-Network Relay. The Remote UE established a unicast link to the respective UE, which acts as its UE-to-Network Relay henceforth.

Once the unicast link is established, a service may be requested as illustrated as Step.2. The UE-to-Network Relay finds that there is a broadcast service or a multicast service advertised by the network. When the Remote UE requests the broadcast/multicast service from the UE-to-Network Relay, the UE-to-Network Relay in turn requests the broadcast/multicast service from the network.

As illustrated as Step. 3, the network transmits the broadcast/multicast traffic to the UE-to-Network Relay and the UE-to-Network Relay receives the broadcast/multicast traffic which is intended for the Remote UE.

When the UE-to-Network Relay receives the broadcast/multicast traffic, the UE-to-Network Relay may decide to relay the broadcast/multicast traffic through the unicast link with the Remote UE, as illustrated as Step. 4. The decision may be based on the number of Remote UEs served by the UE-to-Network Relay simultaneously. For example, when the number of Remote UEs served stays below a threshold, the UE-to-Network Relay may decide to maintain a unicast communication mode. Alternatively, or additionally, the decision may be based on a number of Remote UEs which request the same services, on an extent of the broadcast/multicast traffic, on a load of the UE-to-Network Relay, or on a combination of any of the mentioned factors.

As is illustrated as Step. 5, when the UE-to-Network Relay decides to relay through the unicast link, the broadcast/multicast traffic is transferred by the UE-to-Network Relay from the network, i.e. from the CN and/or the RAN, to the Remote UE through the unicast link between them.

When further Remote UEs join the UE-to-Network Relay, the UE-to-Network Relay may decide to act as UE-to-Network Relay for the further Remote UEs. In this case, the UE-to-Network Relay may establish a unicast link with each of the further Remote UEs and relay broadcast/unicast traffic through each of the respective unicast links to the respective Remote UE. For each of the Remote UE, the operation may comply with the procedure as illustrated in FIG. 2, which may be called a unicast communication mode. As described above with reference to FIG. 1, the UE-to-Network Relay may decide at one point to switch from the unicast communication mode to a broadcast/multicast communication mode.

The unicast communication mode may be simple to establish, resilient and stable to operate, and/or flexible. The broadcast/multicast communication mode may spare a UE-to-Network Relay from maintaining multiple unicast links to multiple Remote UEs. This way, the UE-to-Network Relay may operate more efficiently with respect to radio resources, energy resources, computing resources, and/or memory resources. Further, the broadcast/multicast communication mode may allow for a greater number of Remote UEs to be served by one UE-to-Network Relay.

By operating a UE-to-Network Relay in a unicast communication mode as described with reference to FIG. 1, the Remote UE may be provided with network services reliably even in a case when the Remote UE does not have network coverage. This way, the user experience in the network is improved.

By switching a UE-to-Network Relay from the unicast communication mode to a broadcast/multicast communication mode as described with reference to FIG. 2, acting as a UE-to-Network Relay may be feasible for a UE in more situations, and more Remote UEs may be served more efficiently. This way, the Remote UEs may be provided with network services reliably even when a multitude of Remote UEs desire access to a network and only few UE-to-Network Relay may be available. This way, the user experience in the network is even further improved.

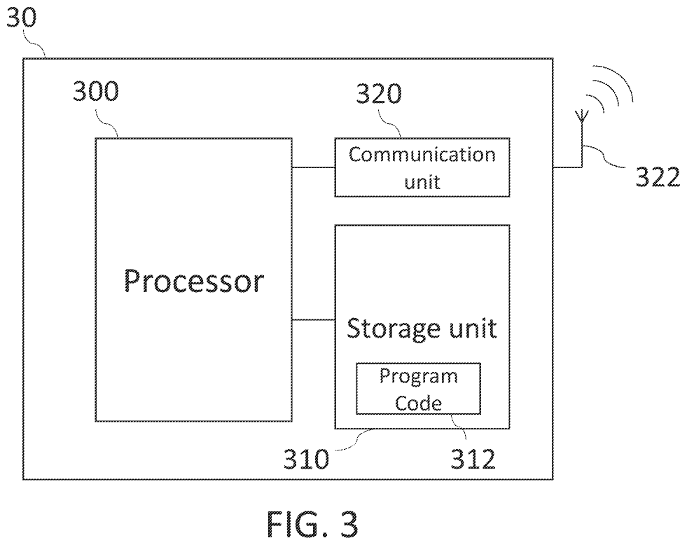

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g. messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g. a base station).

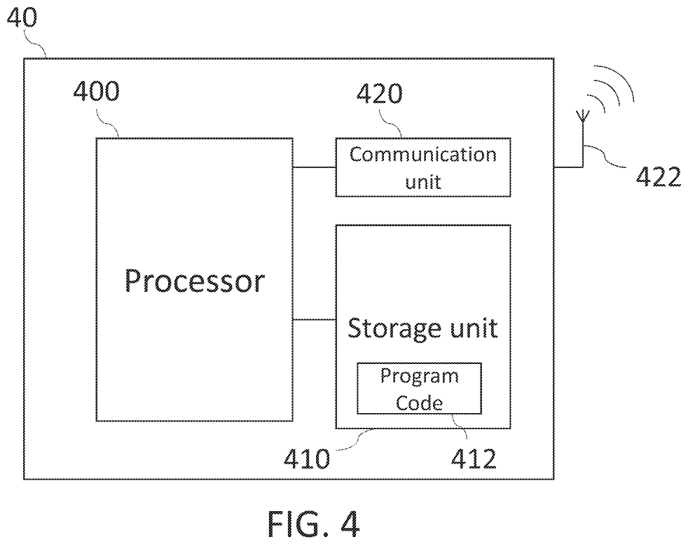

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g. messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g. a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
determining, by a relay wireless communication terminal, whether to change a communication mode with remote wireless communication terminals in response to that a number of the remote wireless communication terminals receiving a same broadcast or multicast traffic from a network is increased; and
transmitting, by the relay wireless communication terminal to the remote wireless communication terminals, an indication that communications between the relay wireless communication terminal and the remote wireless communication terminals for transferring the broadcast or multicast traffic to the remote wireless communication terminals is changed from unicast communications to a broadcast or multicast communication in response to the relay wireless communication terminal determining to change the communication mode.

2. The wireless communication method of claim 1, wherein the relay wireless communication terminal transmits a disconnect request to the remote wireless communication terminals to release the unicast communications between the relay wireless communication terminal and the remote wireless communication terminal.

3. The wireless communication method of claim 1, wherein the relay wireless communication terminal determines a source address identification and a destination address identification for the broadcast according to broadcast service information.

4. The wireless communication method of claim 1, wherein the relay wireless communication terminal determines a source address identification and a destination address identification for the multicast communication according to group information of a multicast service.

5. The wireless communication method of claim 1, wherein the relay wireless communication terminal transfers the broadcast or multicast traffic to the remote wireless communication terminals according to a source address identification and a destination address identification for a broadcast or multicast service corresponding to the broadcast or multicast traffic.

6. The wireless communication method of claim 1, wherein the relay wireless communication terminal establishes a unicast communication with one of the remote wireless communication terminals.

7. The wireless communication method of claim 6, wherein the relay wireless communication terminal receives a request for a broadcast or multicast service from one of the remote wireless communication terminals.

8. The wireless communication method of claim 7, wherein the relay wireless communication terminal requests a broadcast or multicast service from the network in response to a serving cell of the relay wireless communication terminal advertising the broadcast or multicast service.

9. The wireless communication method of claim 8, wherein the relay wireless communication terminal transfers the broadcast or multicast traffic for the broadcast or multicast service from the network to the one of the remote wireless communication terminals via the unicast communication between the one of the remote wireless communication terminals and the relay wireless communication terminal.

10. A wireless communication method comprising:
receiving, by a remote wireless communication terminal from a relay wireless communication terminal, an indication that a communication for transferring a broadcast or multicast traffic from a network via the relay wireless communication terminal is changed from using a unicast communication to using a broadcast or multicast communication.

11. The wireless communication method of claim 10, wherein the remote wireless communication terminal receives a disconnect request from the relay wireless communication terminals to release the unicast communications between the relay wireless communication terminal and the remote wireless communication terminal.

12. The wireless communication method of claim 10, wherein the remote wireless communication terminal determines a destination address identification for the broadcast according to broadcast service information.

13. The wireless communication method of claim 10, wherein the remote wireless communication terminal determines a destination address identification for the multicast communication according to group information of a multicast service.

14. The wireless communication method of claim 10, wherein the remote wireless communication terminal receives for the broadcast or multicast traffic from the network via the relay wireless communication terminal based on a destination address identification for a broadcast or multicast service.

15. The wireless communication method of claim 10, wherein the remote wireless communication terminal establishes a unicast communication with the relay wireless communication terminal.

16. The wireless communication method of claim 15, wherein the remote wireless communication terminal transmits a request for a broadcast or multicast service to the remote wireless communication terminal.

17. The wireless communication method of claim 16, wherein the remote wireless communication terminal receives the broadcast or multicast traffic for the broadcast or multicast service from the network via the unicast communication between the remote wireless communication terminal and the relay wireless communication terminal.

18. A relay wireless communication terminal, comprising:
a communication unit; and
at least one processor configured to: determine whether to change a communication mode with remote wireless communication terminals in response to that a number of the remote wireless communication terminals receiving a same broadcast or multicast traffic from a network is increased; and transmit, via the communication unit, to the remote wireless communication terminals, an indication that communications between the relay wireless communication terminal and the remote wireless communication terminals for transferring the broadcast or multicast traffic to the remote wireless communication terminals is changed from unicast communications to a broadcast or multicast communication in response to the relay wireless communication terminal determining to change the communication mode.

19. The relay wireless communication terminal of claim 18, wherein the at least one processor is further configured to transmit a disconnect request to the remote wireless communication terminals to release the unicast communications between the relay wireless communication terminal and the remote wireless communication terminal.

20. The relay wireless communication terminal of claim 18, wherein the at least one processor is further configured to determine a source address identification and a destination address identification for the broadcast according to broadcast service information.
